(19) United States
(12) Patent Application Publication
(10) Pub. No.: US 2007/0298753 A1
(43) Pub. Date: Dec. 27, 2007

(54) RECHARGEABLE CELLULAR TELEPHONE

(76) Inventors: TOM TARY, Mission (CA); Adis Golic, Burnaby (CA)

Correspondence Address: JOHN RUSSELL UREN, 1590 BELLEVUE AVENUE, SUITE 202, WEST VANCOUVER, BC, V7V1A7, US

(21) Appl. No.: 11/426,000

(22) Filed: Jun. 22, 2006

(51) Int. Cl. H04B 1/16; H04B 1/38

(52) U.S. Cl. 455/343.6; 455/572

(57) ABSTRACT

A cellular telephone utilises a plurality of batteries with each battery having an associated charging circuit. Power is applied to the charging circuit from a charging device which device may be a mechanical rotating member. A control module is associated with each one of the charging circuits and selects the battery or cells of the battery to which the power is to be provided. If one battery or cell is being discharged, the charge is applied to the other non-used battery or cell. If one battery or cell is discharged and the phone is not being used, the power is applied to the lowest voltage battery or cell.

### INTRODUCTION

This invention relates to a cellular telephone having a plurality of batteries and, more particularly, to an improved cellular telephone which utilises a charging circuit to recharge the discharged or unused one of the cells or batteries with power generated from a power generating device.

### BACKGROUND OF THE INVENTION

Batteries for cellular telephones and other personal recording and communicating devices are in pervasive use and continue to be a source of frustration for users. When the device is not being used, it commonly is placed in a cradle uniquely adapted to the cellular telephone which cradle is connected to an AC power supply and a rectifier circuit is used to convert the AC power to DC. Alternatively, the device is recharged by a DC power supply specific and unique to the cellular telephone being charged such as that used in an automobile or other vehicle. After being recharged, the unit is again used until the battery becomes discharged whereupon the telephone is returned to its unique cradle for further recharging.

The need for recharging from a very specific charger is inconvenient. In certain situations, where there is no source of energy for recharging or the specific charger is unavailable and the battery is or becomes discharged, the non-availability of the device can create safety problems. The user may take a second set of fully charged batteries in the event heavy use of the device is anticipated and no charging device is going to be available. However, such batteries, as well, can become discharged. Users may carry a recharging device for the batteries but if no source of electricity is present, such as when camping or in other wilderness excursions, these recharging devices are not usable. It would be useful to allow the electronic devices such as telephones to be charged in the field without the necessity of carrying additional charged batteries and without the necessity of requiring a source of electronic power. SUMMARY OF THE INVENTION

According to one aspect of the invention, there is provided a cellular telephone powered by at least two batteries, each of said batteries having an individual charging circuit and a control module associated with said charging circuit, one of said batteries being associated with a first charging circuit powering said cellular telephone in an operating mode while the other of said batteries is associated with a second charging circuit associated with said cellular telephone in a charging mode.

According to a further aspect of the invention, there is provided a method of operating a cellular telephone comprising the steps of operating said telephone off a first battery associated with a first charging circuit while a second battery associated with a second charging circuit is being charged.

According to a further aspect of the invention, there is provided a cellular telephone having a pair of batteries to power said telephone, each of said batteries being associated with an individual charging circuit, one of said batteries powering said telephone while the second of said batteries is being recharged through its associated charging circuit, said recharging being accomplished by a recharging device which produces power during movement of said cellular telephone.

According to yet a further aspect of the invention, there is provided a method of recharging a first battery of a cellular telephone while a second battery of said cellular telephone is being used to power said cellular telephone, said method comprising producing movement in said cellular telephone to mechanically move a recharging device which produces power to recharge said first battery through a first charging circuit.

### BRIEF DESCRIPTION OF THE SEVERAL VIEWS OF THE DRAWINGS

Specific embodiments of the invention will now be described, by way of example only, with the use of drawings in which:

FIG. 1 is diagrammatic isometric view of a cellular phone according to a first embodiment of the invention;

FIG. 2 is a block diagram diagrammatically illustrating a recharging circuit used to charge one of a plurality of batteries within the cellular telephone;

FIG. 3 is a diagrammatic isometric view of a mechanical charger used to produce power to the recharging circuits associated with the rechargeable batteries; and

FIG. 4 is a diagrammatic schematic view of the charging circuit used with one of the plurality of batteries associated with the cellular telephone of FIG. 1.

### DESCRIPTION OF SPECIFIC EMBODIMENT

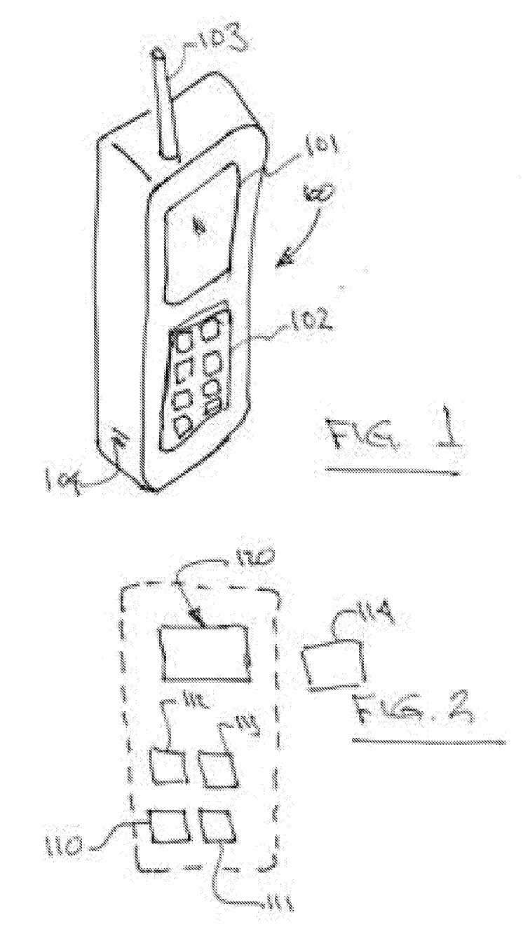

Referring now to the drawings, a cellular telephone is generally illustrated at 100 in FIG. 1. It comprises a screen 101 which carries information on the status of the telephone 100 and a keypad generally illustrated at 102 which is used to input power and information to the telephone 100. An aerial 103 of a retractable nature is mounted on the top of the telephone 100 to enhance reception of the transmitted frequencies. Contacts 104 are positioned on the side of telephone 100 which contacts are designed to be associated with a recharging device (not shown) which recharging device is usually associated with an AC power source. A further port (not illustrated) on the bottom of the telephone 100 is associated with a second power source which is generally a DC power source such as is available in a vehicle or boat and which second power source generally uses a cable which extends from the second power source such as a cigarette lighter in the vehicle or boat to the port of the telephone 100.

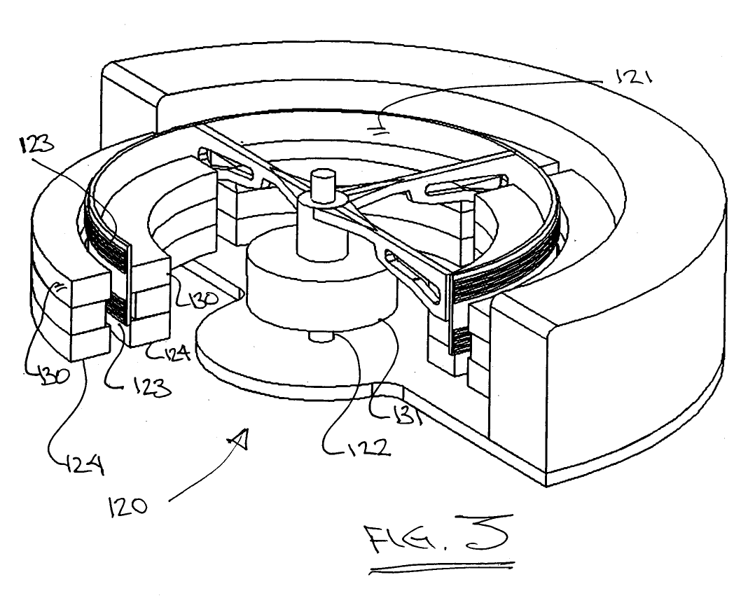

Referring to FIG. 2, a pair of rechargeable batteries 110, 111 are illustrated as being within the cellular telephone 100 although more batteries than two could conveniently be utilised. Each of the batteries 110, 111 has an associated charging circuit 112, 113, respectively; that is, first battery 110 has a first associated charging circuit 112 and second battery 111 has a second associated charging circuit 113. An outside charging source 114 is associated with the cellular telephone 100. It may be, for example, a source of AC power such as an wall plug or a source of DC power such as usually present in a vehicle or boat. This power source 114 can conveniently be connected to the telephone 100 when such a power source is available. The charging circuit is therefore adaptable to accommodate a broad range of available voltages.

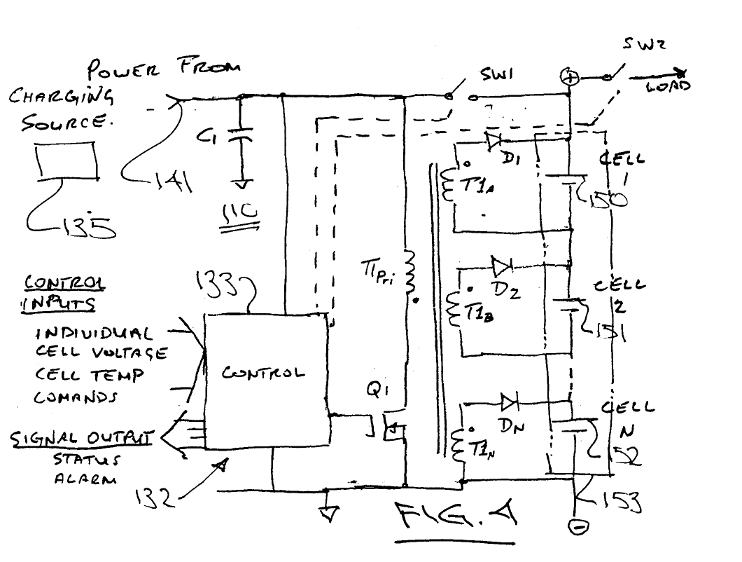

A mechanical charger generally illustrated at 120 is provided within the cellular telephone 100 and such a charger 120 is illustrated in greater detail in FIG. 3. The mechanical charger 120 resembles the rewinding mechanism in an automatic watch; that is, a rotary and eccentrically configured member 121 is mounted on an axle 122. Two windings 123 are mounted about the circumference of the eccentric member 121 and these windings 123 move within the field of stationary magnets 124, 130. As the axle 122 rotates upon manual movement of the cellular telephone 100 in which it is mounted, the collar 131 translates the rotary movement of axle 122 into an up and down or reciprocal movement of member 121. As the axle 122 rotates, the collar 131 will move upwardly and when it reaches its uppermost position, collar 131 acts to release the member 121 so that it quickly moves downwardly relative to the magnets 124, 130. The windings 123 therefore sever the flux lines extending between the opposite poled magnets 124, 130 on the inside and outside of the windings 123 thereby creating an AC current which is converted to DC through a rectifier 135 (FIG. 4). This DC current drawn from the windings 123 thereby is provided to the charging circuit generally illustrated at 132 which charging circuit 132 provides or withdraws power from the cells 150, 151, 152 of the battery 110 and corresponding cells (not illustrated) of the second battery 111.

The charging circuit 132 comprises a control module 133 for the first battery 110 which detects a weak or failed one of the cells 150, 151, 152 with each of the cells 150, 151, 152 being operably connected to the control module 133. The cells 150, 151, 152 are mounted on a thermally conductive substrate 153, conveniently aluminum, which ensures the temperatures of the cells 150, 151, 152 are similar. If charging of the cells 150, 151, 152 is required, SW1 and SW2 will be open and the telephone 100 will not be in use. With SW1 and SW2 open, the power from the charger 120 of FIG. 3 will be applied at point 141 and this power will be applied to the cells 150, 151, 152 of battery 110 with the lowest voltage one of the cells 150, 151, 152 receiving the greatest charge.

The control module 133 is designed to detect a voltage in one cell which voltage is lower than the voltages of the remaining ones of the cells. If the telephone 100 is being used, SW2 will be closed and SW1 will be open with power being drawn from the cells 150, 151, 152. In the event the control module 133 detects a voltage of one of the cells which is lower than the remaining cells, SW1 will close. Power will thereby be drawn from all three cells 150, 151, 152 thereby avoiding failure of the battery by compensating for the failed cell.

The second battery 111 has an associated charging circuit (not illustrated) identical to the charging circuit 132 of first battery 110.

An independent control module for each of the batteries 110, 111 utilised in the telephone 100 is contemplated. In the event the control module associated with one of the cells 150, 151, 152 signals a discharged or failed cell, the other one of the cells 150, 151, 152 will be brought online to provide power to the telephone 100 in a circuit identical to the circuit illustrated in FIG. 4. The power received from the charger 120 will be provided to the circuit associated with the second one of the batteries 110, 111 in the event one of the circuits is discharging as would be the case when the telephone 100 is in use. By charging one circuit when the other circuit is being discharged under use, one of the batteries 110, 111 will always carry a charge which can be used to allow continued use of the cellular telephone 100. A battery controller, not illustrated, will route power to the proper one of the batteries 110, 111 in the same manner as the control module 133 just described.

The source of the power applied to the charging circuit 132 may be one of various types For example, solar power could be used with appropriate solar panels being used on the telephone 100 to generate the current used to charge the batteries through the charging circuit 132. Alternatively, a manual charging mechanism could also be used with a crank used to generate current within a winding which current is applied at point 141 in FIG. 4. Other types of current generation could also be used but the use of a rotary member 120 movable when the cellular telephone 100 is moved or the use of solar power panels (not illustrated) is considered to be the most desirable of such alternatives.

While the charging circuits and power generator have been described in association with a cellular telephone, it is apparent that the same teachings could be applied to virtually any personal digital assistant (PDA) or any other personal electronic and portable device which utilises batteries and where the power drain from the batteries necessitates frequent charging and replacement.

Many further embodiments will readily occur to those skilled in the art to which the invention relates and the specific embodiments herein described should be taken as illustrative of the invention only and not as limiting its scope as defined in accordance with the accompanying claims.

I claim:

1. A cellular telephone powered by at least two batteries, each of said batteries having an individual charging circuit and a control module associated with said charging circuit, one of said batteries being associated with a first charging circuit powering said cellular telephone in an operating mode while the other of said batteries is associated with a second charging circuit associated with said cellular telephone in a charging mode.

2. A method of operating a cellular telephone comprising the steps of operating said telephone off a first battery associated with a first charging circuit while a second battery associated with a second charging circuit is being charged.

3. A cellular telephone having a pair of batteries to power said telephone, each of said batteries being associated with an individual charging circuit, one of said batteries powering said telephone while the second of said batteries is being recharged through its associated charging circuit, said recharging being accomplished by a recharging device which produces power during movement of said cellular telephone.

4. A method of recharging a first battery of a cellular telephone while a second battery of said cellular telephone is being used to power said cellular telephone, said method comprising producing movement in said cellular telephone to mechanically move a recharging device which produces power to recharge said first battery through a first charging circuit.
